(19) United States
(12) Patent Application Publication
(10) Pub. No.: US 2003/0065066 A1
(43) Pub. Date: Apr. 3, 2003

(54) Triazine UV absorbers comprising amino resins

(76) Inventors: Dennis John Jakiela, Orange, CT (US); Ram Baboo Gupta, Stamford, CT (US); Thomas P. Sassi, Stamford, CT (US); Gottfried Haacke, New Canaan, CT (US)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/202,228

(22) Filed: Jul. 23, 2002

Related U.S. Application Data
(63) Continuation of application No. 09/667,287, filed on Sep. 22, 2000, now abandoned.
Application No. 09/667,287 is a continuation of application No. 09/197,746, filed on Nov. 20, 1998, now abandoned.
(60) Provisional application No. 60/090,262, filed on Jun. 22, 1998.

(51) Int. Cl. C08K 5/34

(52) U.S. Cl. 524/100

(57) ABSTRACT

A novel class of UV absorbers, ortho-hydroxyphenyl substituted triazine compounds bonded to aminoplast resins is provided. Compared to unanchored stabilizers, the anchored stabilizers disclosed herein have increased compatibility with coating resins and have reduced volatility due to higher molecular weights resulting from anchoring. A process for preparing the anchored stabilizers by the reaction of triazines containing active hydrogen with alkoxymethylated aminoplasts in the presence of a catalytic amount of acid. The novel ortho-hydroxylphenyl substituted triazine compounds are bound to the aminoplast resins by carbon-oxygen, carbon-carbamoyl nitrogen or carbon-active methylene carbon linkages. The aminoplasts include alkoxymethylated derivatives of glycolurils, melamines, and urea-formaldehyde resins.

### FIELD OF THE INVENTION

This invention relates to the preparation and use of novel aminoplast-anchored triazine ultraviolet light stabilizers.

### BACKGROUND OF THE INVENTION

Stabilization of polymers by incorporation of ultraviolet light stabilizers, particularly trisaryl triazine UV light absorbers, in polymer films, coatings, fibers, and molded articles to provide protection against the degrading action of light, moisture, or oxygen has been an active area of work in recent years. However, deficiencies such as solubility in coatings solvents and formulations, volatility and generally poor solubility and poor retention of existing stabilizers within a polymer matrix still remain largely unsolved. For example, attempts to reduce volatility by using higher molecular weight oligomers and polymers have generally resulted in a decreased retention of the stabilizer due to incompatibility. Extractibility and migration of the stabilizer to the surface and eventually loss as a result of incompatibility or low molecular weight are still serious problems plaguing the plastics industry.

Limited attempts to increase the molecular weight of the trisaryl triazine stabilizer without introducing incompatibility by using anchor groups have been made in the past without great success. More recently, U.S. Pat. Nos. 5,547,753; 5,612,084 and 5,621,052 have described aminoplast anchored UV absorbers having a carbon-carbon bond. The processes for making these compounds, however, require concentrated sulfuric acid as a solvent. The use of sulfuric acid as a solvent has several drawbacks, including difficulty in handling on an industrial scale, isolation of the product from sulfuric acid and oligomerization of amino resins to insoluble materials. Moreover, the use of sulfuric acid is not practicable for triazines containing functionalities which are unstable in strong acids. Thus, there remains a need for a process to make desirable aminoplast anchored products having higher molecular weight, low volatility, improved solubility and compatibility with the polymer matrix. Accordingly, it is an object of the invention to provide a novel class of triazine compounds bonded to aminoplast resins, such as alkoxymethylated melamines by carbon-oxygen, carbon-carbamoyl nitrogen and carbon-active methylene carbon bonds.

Another object of this invention is to provide a process for the preparation of the novel stabilizers of the invention.

It is a further object of the invention to provide a process for making the compounds haing higher molecular weight, low volatility and improved solubility and compatibility with the polymer matrix.

It is yet another object of this invention to provide curable compositions containing the novel stabilizers of the invention and also provide stabilized cured compositions obtained by curing said curable compositions.

It is yet another object of this invention to provide an improved method of stabilizing polymers wherein the improvement comprises adding to said polymers the novel stabilizers of the invention.

### SUMMARY OF THE INVENTION

The present invention provides a novel class of UV absorbers, ortho-hydroxyphenyl substituted triazine compounds bonded to aminoplast resins, such as alkoxymethylated melamines, glycourils, and urea-formaldehyde resins. This invention is also a process for preparing the novel UV absorbers of the invention.

This invention is also a curable composition containing the novel UV absorbers the invention.

This invention is also an improved method of stabilizing polymers wherein the improvement comprises adding to said polymers the novel stabilizers of the invention.

The advantages of the anchored stabilizers of this invention over their unanchored precursors include generally higher solubility and compatibility with polymers and resins, reduced migration between coating film layers, and generally lower volatility due to higher molecular weights.

### DETAILED DESCRIPTION OF THE INVENTION

The novel composition of this invention is a new class of UV absorbers depicted below, ortho-hydroxyphenyl substituted triazine compounds bonded to aminoplast resins such as alkoxymethylated melamines, glycolurils and urea-formaldehyde resins.

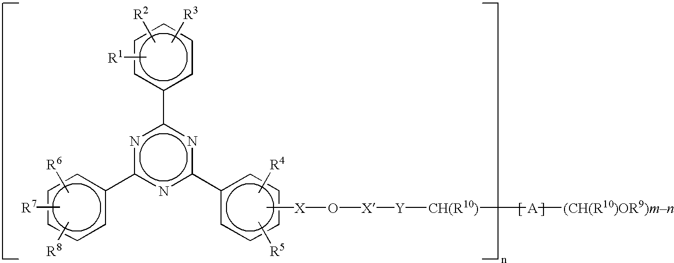

wherein

A is an m-functional monomeric or oligomeric aminoplast anchor molecule having at least 0.1 mole of bondable trisaryl-1,3,5-triazine UV absorber per mole of aminoplast anchor bonded thereto through n bridging groups, such bridging groups being selected from methylene and —CHR¹⁰— groups;

each of R¹-R⁸ are independently selected from hydrogen, cyano, chloro, bromo,-nitro, alkyl of 1 to 24 carbon atoms, aryl of 6 to 24 carbon atoms, aralkyl of 7 to 24 carbon atoms, hydroxy, alkoxy of 1 to 24 carbon atoms and alkyl of 1 to 24 carbon atoms optionally substituted by one or more oxygen atoms and/or carbonyl groups, with the proviso that at least one of R¹-R⁸ is ortho to the point of attachment of the triazine ring, and is a hydroxyl or a latent hydroxyl group blocked with an alkyl, phenyl, aryl, acyl, aryl acyl, aminocarbonyl, phosphonyl, sulfonyl or silyl group containing 1 to 18 carbon atoms;

X and X′ are independently a direct bond, a branched or straight chain alkylene group of 1 to 24 carbon atoms, a branched or straight chain alkylene group of 1 to 24 carbon atoms terminated or interrupted by one or more groups selected from —O—, —NH—, —NR⁹—, —CONH—, —CONR⁹, one or more carbonyl groups or combinations thereof;

Y is a direct bond, —CONR⁹—,

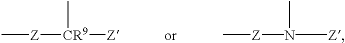

wherein Z is —CO—, —CO⁻M⁺, —CONR⁹, —SO— or —SO₂; and Z′ is —COOR⁹, —COO⁻M⁺, —CHO, —COR⁹, —CONR⁹, —CN, —NO₂, —SOR⁹, —SO₂R⁹, —SO₂OR⁹, —SO₂NR₂⁹;

R⁹ and R¹⁰ are independently selected from the group consisting of hydrogen, linear or branched alkyl of 1 to 24 carbon atoms, aryl of 6 to 24 carbon atoms or aralkyl of 7 to 24 carbon atoms;

m is at least 1; and

n is at least 0.1.

The broad discovery of this invention is that chemically combining amino resin anchors and certain bondable trisaryl-1,3,5-triazine UV absorbers yields compositions of matter which surprisingly retain the stabilizing effect of the trisaryl-s-triazine UV absorber, permits combinations of different bondable UV absorbers in the same composition, and gains advantageous properties from the amino resins such as enhanced solubility and compatibility with coating solvents, and reduced volatility.

For example, the gain in solubility achieved by reacting bondable trisaryl-s-triazine UV absorbers with amino resins not only makes these compositions more soluble and compatible with the coating solvents and formulations, but also makes the compositions more compatible with the final cured coating film, thereby minimizing blooming to the surface, extractibility and the resulting loss of the stabilizer to the environment. Also, the gain in molecular weight achieved by reacting the bondable trisaryl-s-triazine UV absorbers with amino resins makes the compositions less volatile, thereby minimizing losses during high temperature bakes.

The present invention provides a wide variety of anchored stabilizers because of the ability to change any of the following variables:

1. The type of amino resin anchors.

2. The type of trisaryl substituted triazine reactant(s).

3. The degree of reaction of (1.) and (2.) (extent of substitution).

The following sections of this Detailed Description will illustrate useful types of amino resins for formation of the novel compounds of the invention. By way of example, specific use of the following amino resin types is set forth below:

1. melamine type resins

2. glycoluril type resins

3. urea-formaldehyde type resins

The following sections will also illustrate the variety of novel compounds resulting from the degree of reaction between the amino resin anchor and the stabilizer.

The amino resin anchor may be fully or partially reacted with the stabilizer, creating three categories of novel compounds as follows:

1. Amino resin/stabilizer compounds wherein the stabilizer is on the average reacted with substantially all of the available reactive sites on the amino resin. This results in a novel compound having a high degree of stabilizer activity and reduced volatility.

2. Amino resin/stabilizer compounds wherein the stabilizer is on the average reacted with all but one of the available reactive sites on the amino resin. This results in a novel compound which can chemically combine with plastics which are known to react with amino resins to give a pendant group with stabilizer functionality.

3. Amino resin/stabilizer compounds wherein the stabilizer is on the average reacted so as to leave two or more available reactive sites on the amino resin. This results in a novel compound which can chemically act as a crosslinking agent. Such novel crosslinking agents also act as stabilizers.

The word “stabilizer” is used herein to mean the ortho-hydroxyphenyl substituted triazine compounds of the present invention. These compounds are known to have utility to prevent degradation by environmental forces, inclusive of ultraviolet light, actinic radiation, oxidation, moisture, atmospheric pollutants, and combinations thereof.

The novel aminoplast-anchored trisaryl-substituted-triazines, optionally in combination with the other UV stabilizers, of the invention have a monomeric or oligomeric aminoplast nucleus which has more than 0.1 mole of trisaryl substituted triazine UV stabilizer groups per mole of aminoplast pendently attached thereto with methylene bridges. Generically, the novel stabilizers of this invention may be represented by the following formula:

(UV Absorber)ₙ-A-(CH(R¹⁰)OR⁹)ₘ₋ₙ

wherein

at least one UV absorber is a bondable trisaryl-s-triazine as described in the present invention;

A is a monomeric or oligomeric aminoplast anchor molecule serving as a nucleus for supporting the pendently attached trisaryl substituted triazine UV stabilizer groups; and

n is a number having an average minimum value greater than 0.1 and a maximum value equal to the number of stabilizer-reactive groups present on the aminoplast anchor.

The stabilizer-reactive group in the aminoplast anchor molecule is typically an alkoxymethyl group, but other reactive groups, such as hydroxy, acyloxy, halo, mercapto, sulfonyl, sulfonate, sulfate, phosphate, dialkylsulfonium, trialkylammonium, and the like may also be used.

It should be specifically noted that in addition to the bondable trisaryl-1,3,5-triazine groups described above, bondable UV absorbers from other classes may also be combined in the same aminoplast anchor molecule. Thus, in addition to bondable trisaryl-1,3,5-triazine groups of the present invention, any one or more of the following classes of UV absorbers may be present:

(1) other bondable 2-(2-hydroxyphenyl)-1,3,5-triazines

(2) bondable 2-(2-hydroxyphenyl)benzotriazoles

(3) bondable 2-hydroxybenzophenones

(4) bondable 2-hydroxyoxanilides

(5) bondable salicylic acid derivatives

(6) latent derivatives of (1) through (5), wherein the phenolic 2-hydroxyl group is blocked with a suitable blocking group.

The presence of more than one class of UV absorber in the same amino resin molecule, for example the combination of a bondable 2-(2-hydroxyphenyl)-1,3,5-triazine and a bondable 2-(2-hydroxyphenyl)benzotriazole in the same molecule, provides a novel composition with UV absorbance over a broad spectral range.

Most preferred embodiments of the invention are UV absorbers of the above formula, wherein A is a melamine anchor.

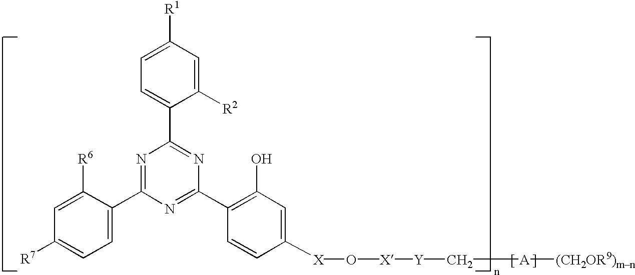

wherein

A is an m-functional monomeric or oligomeric aminoplast anchor molecule to which n bondable trisaryl-1,3,5-triazine UV absorbers are bonded through a methylene linkage;

X, X′ and Y are as described above;

R¹, R², R⁶ and R⁷ are independently selected from hydrogen, chloro, cyano, alkyl of 1 to 24 carbon atoms, aryl of 6 to 24 carbon atoms and aralkyl of 7 to 24 carbon atoms; and

R⁹ is C¹ to C⁵ alkyl.

### AMINOPLAST ANCHORS

The aminoplast anchor molecules of this invention are aminoplast crosslinkers commonly used in coatings, moldings, and adhesives. The term “aminoplast” is defined herein as a class of resins which may be prepared by the reaction of an amino group-containing compound and an aldehyde.

The reaction product of amino group-containing compounds and aldehyde is often reacted further with an alcohol to produce partially or fully alkylated derivatives. These derivatives are included in the “aminoplast” definition given above. The term “aminoplast” as used in the context of this invention comprises typically a polyfunctional amino resin. and may be monomeric or oligomeric. For example, in the preparation of aminoplasts from amino group-containing compounds and aldehydes and subsequent alkylation, dimeric and oligomeric products resulting from self-condensation reaction are often obtained. These oligomeric self-condensation products are included in the “aminoplast” definition given above.

By way of example, the aminoplast anchors A of this invention include the groups represented by the following formulae:

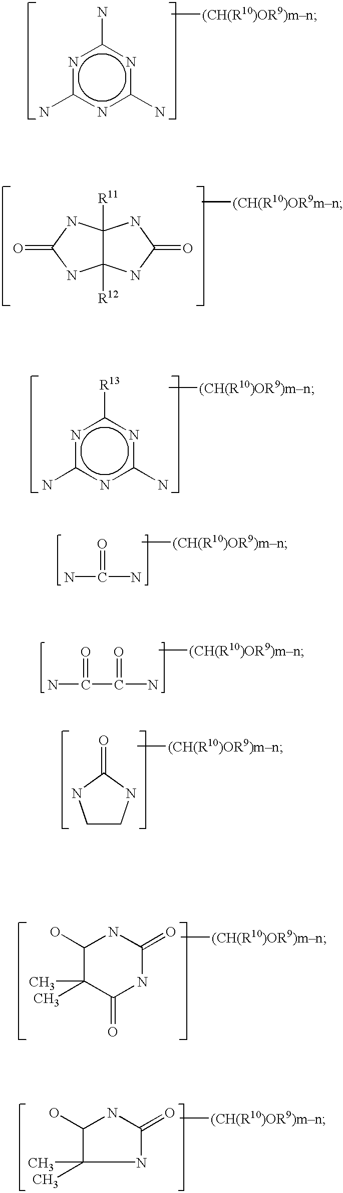

polyfunctional carbamates;

polyfunctional amides;

hydantoins;

dialkoxyethylene ureas;

dihydroxyethylene urea represented by the formula:

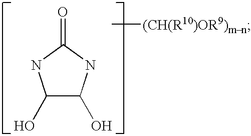

homopolymers and copolymers containing carbamate units of the formula:

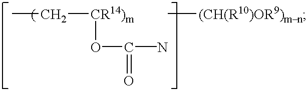

oligomeric derivatives thereof; and non-etherified or partially etherified, substantially fully methylolated or partially methylolated monomeric and oligomeric aminoplasts; wherein

R⁹ is hydrogen or a linear or branched alkyl group of 1 to 24 carbon atoms;

R¹¹ and R¹² are independently, hydrogen, alkyl or aryl groups of 1 to 24 carbon atoms;

R¹³ is an aliphatic or cycloaliphatic alkyl group of 1 to 24 carbon atoms; an aromatic group of 1 to 24 carbon; atoms or an aralkyl group of 1 to 24 carbon atoms; and

R¹⁴ is hydrogen or alkyl of 1 to 24 carbon atoms, and m is at least 1; and

oligomeric derivatives thereof.

The aminoplast may have, as a substituent, a hydrogen, an alkyl or an aryl group of 1 to about 20 carbon atoms, or a stabilizer reactive group such as —CH₂OH and —CH₂OR⁹ wherein R⁹ is an alkyl group of 1 to about 20 carbon atoms or an aminoplast group-containing oligomeric group provided that the total number of stabilizer reactive groups per each aminoplast anchor is at least 1, and preferably more than 1.

The preferred aminoplast anchors of this invention are substantially fully etherified, substantially fully methylolated, substantially monomeric aminoplast crosslinkers commonly used in the coatings industry. They are characterized by having at least two, and preferably more than two, stabilizer-reactive groups per anchor molecule.

The most preferred aminoplast anchors of the invention are selected from a group consisting of substantially fully etherified, substantially fully methylolated, substantially monomeric glycoluril, melamine, benzoguanamine, cyclohexanecarboguanamine, urea, and mixtures thereof.

In addition to the substantially fully etherified, substantially monomeric amine-aldehyde aminoplast anchors described above, the non-etherified or partially etherified, substantially fully methylolated or partially methylolated monomeric and oligomeric aminoplasts are also usable in the composition of this invention.

Aminoplast anchors which contain very few alkoxymethyl groups generally have low solubilities due to the high N—H levels, and therefore are less preferred.

The most preferred aminoplast anchors are exemplified in greater detail below.

### Melamine Anchors

The melamine-based aminoplast anchors of this invention are well known per se, and have been used extensively as effective crosslinkers in coatings. The melamine anchors of this invention are represented by the formula

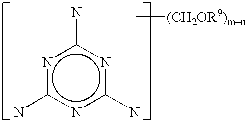

wherein

R⁹ is hydrogen or a linear or branched alkyl group of 1 to 24 carbon atoms.

Unlike the tetrafunctional glycolurils, alkoxymethylmelamine functionality can be a maximum of six in a stabilizingly effective range of 1 to 6 stabilizer reactive alkoxymethyl groups per each melamine molecule.

Like the glycolurils, in addition to monomers, alkoxymethyl melamines can contain diners, trimers, tetramers, and higher oligomers, each given combination of monomers and oligomers being preferred for a given application. For example, the lower viscosity monomer-rich compositions are preferred for solvent-based high solids coatings.

An example of a substantially fully etherified, substantially fully methylolated, substantially monomeric melamines usable in this invention is CYMEL® 303 melamine crosslinking agent, a product of Cytec Industries, Inc., West Paterson, N.J., which has the following formula and properties:

Non-Volatiles (% by weight)*: 98 Color, maximum (Gardner 1963): 1 Viscosity (Gardner-Holt, 25° C.): X-Z₂ Free Formaldehyde, maximum (weight %): 0.5 Degree of Polymerization: 1.75*Foil Method (45° C./45 min.)

Another example of a substantially fully etherified, substantially fully methylolated, substantially monomeric melamine is CYMEL® 1168 aminoplast resin, a product of Cytec Industries, Inc., West Paterson, N.J. The alkyl group in CYMEL® 1168 consists essentially of a mixture of methyl and isobutyl groups.

It has the following formula (wherein R=methyl or isobutyl) and properties:

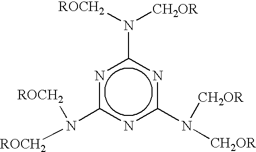

Non-Volatiles (% by weight)*: 98 Color, maximum (Gardner 1963): 1 Free Formaldehyde, maximum (weight %): 0.5 Viscosity (Gardner-Holt, 25° C.): X-Z₂ Equivalent weight: 150-230*Foil Method (45° C./45 min.)

An example of substantially methylolated, partially etherified, substantially oligomeric melamine is CYMEL® 370 crosslinking agent, a product of Cytec Industries, Inc., West Paterson, N.J. It has the following properties: Non-Volatiles (% by weight)*: 88±2 Solvent: Isobutanol Viscosity (Gardner-Holt, 25° C.): Z₂-Z₄ Color, maximum (Gardner 1963): 1 Equivalent weight: 225-325*Foil Method (45° C./45 min.)

### GLYCOLURIL ANCHORS

The glycoluril anchors of this invention are N-substituted glycolurils represented by the formula:

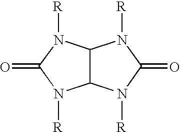

wherein at least two of the R groups are selected from the group consisting of methoxymethyl, ethoxymethyl, propoxymethyl, butoxymethyl, pentoxymethyl, bexoxymethyl, heptoxymethyl, octoxymethyl, nonoxymethyl, decoxymethyl and mixtures thereof, and the remaining R groups are selected from hydrogen, alkyl, hydroxymethyl, and glycoluril group- containing oligomeric moieties.

While it is preferable to have a multiplicity of alkoxymethyl groups per each glycoluril anchor molecule, under ordinary circumstances it is not necessary to obtain, for example, a pure tetra-substituted monomeric aminoplast such as N, N′,N″,N′″-tetraalkoxymethylglycoluril represented by formula:

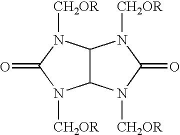

wherein R is an alkyl group of 1 to about 20 carbon atoms. The glycoluril may contain monomeric as well as oligomeric components.

The monomeric tetraalkoxyglycolurils themselves are not considered to be resinous materials since they are, as individual entities, non-polymeric compounds. They are considered, however, to be potential resin-forming compounds when subjected to heat, and particularly when subjected to heat under acidic conditions. As a result of the described resin-forming ability, the substantially monomeric glycoluril aminoplasts of this invention may produce, during the course of the reaction, varying amounts of oligomeric components such as dimers, trimers, and tetramers. The presence of varying amounts of these oligomeric forms is permissible and, indeed beneficial, particularly in cases where higher molecular weight and lower volatility products are desired as in the case of most applications in which the products are used as stabilizers against the degrading action of UV light. An example of glycoluril anchors of this invention is POWDERLINK® 1174 powder aminoplast resin, a product of Cytec Industries, Inc., West Paterson, N.J. It has the following formula and properties:

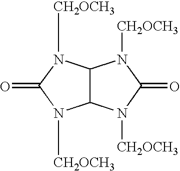

Non Volatiles, minimum (% by weight): 98 Appearance:

White to pale yellow granulated flakes Melting Point (° C.): 90° -110° C. Average Molecular Weight: 350 Equivalent Weight 90-125

Another example of a glycoluril anchor usable in this invention is CYMEL® 1170 fully butylated glycoluril resin, a product of Cytec Industries, Inc., West Paterson, N.J., having the following properties:

Non Volatiles, minimum (% by weight): 95 Appearance: Clear liquid Color, Maximum (Gardner 1963): 3 Viscosity (Gardner-Holt, 25° C.): X-Z₂ Average Molecular Weight: 550 Equivalent Weight: 150-230 Methylol Content: Very low

### UREA ANCHORS

An example of a urea usable in this invention is BEETLE® 80 butylated urea-formaldehyde resin, a product of Cytec Industries, Inc., West Paterson, N.J., having the following properties:

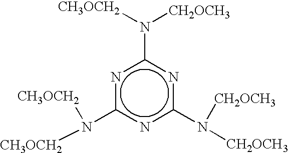

Appearance: Clear Liquid Color, Maximum (Gardner 1963): 1 Non-Volatiles (Weight %)*96±2 Viscosity (Gardner-Holt, 25° C.) X-Z₃ Solvent Tolerance (ASTM D1198-55): >500*Foil Method (45° C./45 min.)

### GUANAMINE ANCHORS

As in melamines, the partially or fully methylolated or etherified alkyl and aryl guanamine aminoplasts, both in their monomeric and oligomeric forms, are usable as anchors in this invention, with the selection depending on the particular application or the properties desired in the product.

Benzoguanamine, cyclohexylcarboguanamine and acetoguanamine aminoplasts are especially preferred as anchors in this invention. The benzoguanamines are represented by the formula:

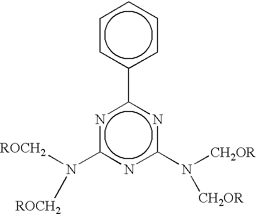

wherein R is an alkyl group of 1 to about 20 carbon atoms, or a mixture thereof. An example of a benzoguanamine-based anchor is CYMEL® 1123 resin as described above, wherein R is a mixture of methyl and ethyl groups.

The acetoguanamine-based anchors are represented by the formula:

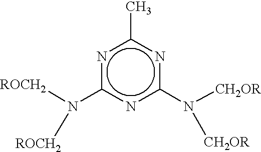

wherein R⁹ is an alkyl group of 1 to about 20 carbon atoms, or a mixture thereof.

The cyclohexylcarboguanamine-based anchors are represented by the formula:

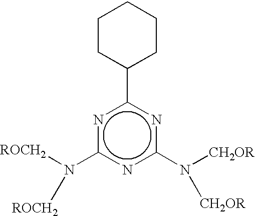

wherein R⁹ is an alkyl group of 1 to about 20 carbon atoms, or a mixture thereof.

It is evident from the above, that a person skilled in the art, in selecting suitable anchors for a particular application, may choose a mixture thereof which imparts a balance of properties desired for that particular application.

### AMINOPLAST ANCHORED STABILIZERS

The aminoplast anchored trisaryl-1,3,5-triazine UV stabilizers of the invention are represented by the formula:

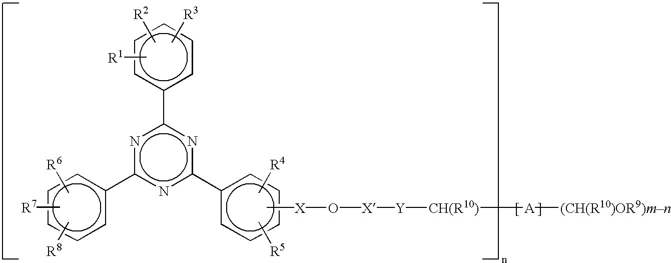

wherein

A is an m functional aminoplast anchor molecule to which n bondable trisaryl-1,3,5-triazine molecules are attached through n methylene (or alkylidene) bridges, said aminoplast anchor molecules are selected from the group consisting of:

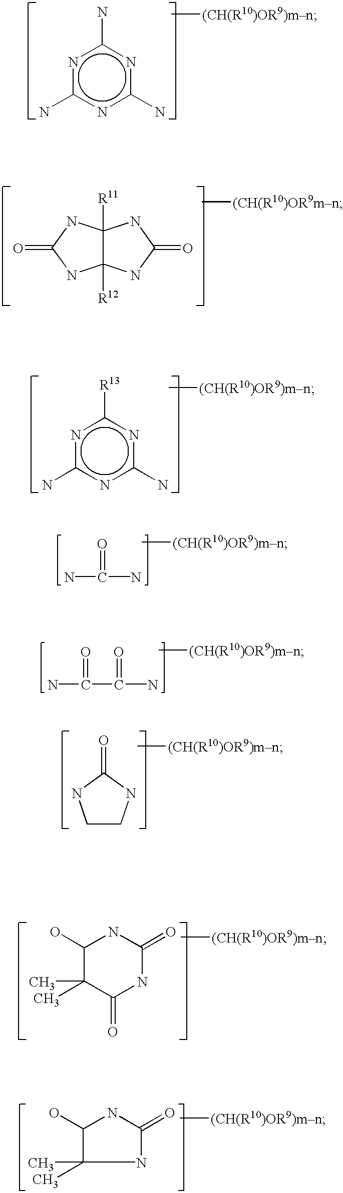

polyfunctional carbamates;

polyfunctional amides;

hydantoins;

dialkoxyethylene ureas;

dihydroxyethylene urea represented by the formula:

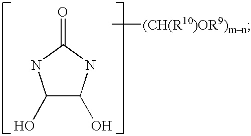

homopolymers and copolymers containing carbamate units of the formula:

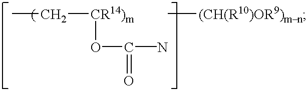

oligomeric derivatives thereof; and non-etherified or partially etherified, substantially fully methylolated or partially methylolated monomeric and oligomeric aminoplasts; wherein

R⁹ is hydrogen or a linear or branched alkyl group of 1 to 24 carbon atoms;

R¹¹ and R¹² are independently, hydrogen, alkyl or aryl groups of 1 to 24 carbon atoms;

R¹³ is an aliphatic or cycloaliphatic alkyl group of 1 to 24 carbon atoms; an aromatic group of 1 to 24 carbon; atoms or an aralkyl group of 1 to 24 carbon atoms; and

R¹⁴ is hydrogen or alkyl of 1 to 24 carbon atoms, and m is at least 1.

Preferred novel trisaryl-1,3,5-triazine substituted aminoplast anchored UV absorbers of the present invention are those wherein A is a melamine anchor, m is between about 1 to 5 per melamine ring, n is between about 1 to 5 per melamine ring, the ratio of bondable trisaryl-1,3,5-triazine to melamine anchor is from about 1:1 to 5:1 and wherein the melamine anchor is a mixture of monomeric, dimeric, trimeric, tetrameric and higher oligomeric units bridged by methylene or methylene-oxy-methylene groups.

More specifically, the preferred novel trisaryl-1,3,5-triazine substituted aminoplast anchored UV absorbers of the present invention have the following general formula

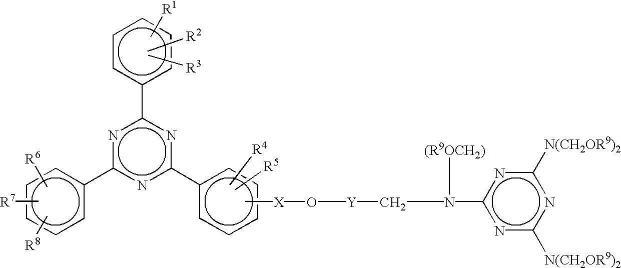

The above formula is an idealized structure representing 1:1 adducts of hexalkoxylmethylmelamine with bondable trisaryl-1,3,5-triazine UV absorbers. The formula is used for he sake of clarity.

Each of R¹—R⁹, X, X′ and Y are as described above.

The amino resin adducts of the present invention are derived from the reaction of trisaryl substituted triazine UV absorbers with an active hydrogen, such UV absorbers being described by the following general formula:

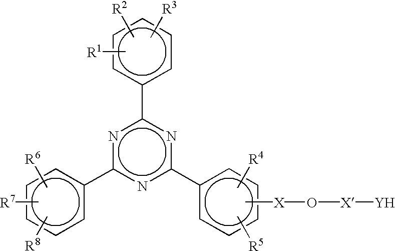

wherein

the group —X—O—X′—Y—H can be selected from

—O(CH₂)_{N}OH N=1-24

—OCH₂CH(OH)CH₃

—OCH₂CH(OH)(CH₂)₃CH₃

—OCH₂CH(OH)(CH₂)₅CH₃

—OCH₂CH(OH)(CH₂)₇CH₃

—OCH₂CH(OH)(CH₂)₁₁CH₃

—OCH₂CH(OH)Ph

—OCH₂CH(OH)(CH₂)₉CH₃

—OCH₂CH(OH)CH₂OH

—OCH₂CH(OH)CH₂OC₄H₉

—OCH₂CH(OH)CH₂OC₆H₁₃

—OCH₂CH(OH)CH₂OC₈H₁₇

—OCH₂CH(OH)CH₂OCH(C₂H₅)C₅H₁₀

—OCH₂CH(OH)CH₂O(C₁₃H₂₇ to C₁₅H₃₁)

—OCH₂CH(OH)CH₂O(C₁₂H₂₅ to C₁₄H₂₉)

—OCH₂CH(OH)CH₂OPh

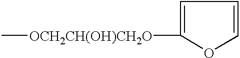

—OCH₂CH(OH)CH₂OCOC₉H₁₉

—OCH₂CH(OH)CH₂OCOC₁₀H₂₁ (isomer mixture)

—OCH₂CH(OH)(CH₂)OCOC(CH₃)═CH₂

—OCH₂CONEt(CH₂)₂OH

—OCH₂COO(CH₂CH₂O)₃H

—OCH₂COO(CH₂CH₂O)₇H

—OCH₂COOCH₂CH(OH)CH₂OCOCH═CH₂

—OCH₂COOCH₂CH(OH)CH₂P(O)(OC₄H₉)₂

—O(CH₂CH₂O)ₙH n=7-9

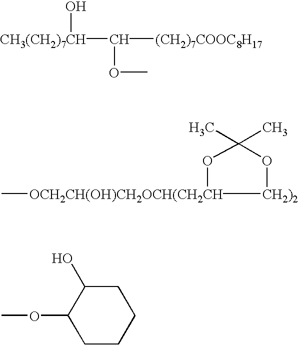

—OCH₂CH(OH)CH₂OCOCH═CH₂

—OCH₂CH(OH)CH₂OCOC(CH₃)═CH₂

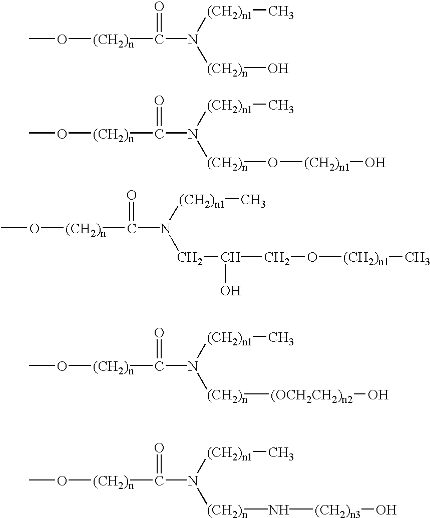

wherein n=1-24, n₁=0-23,n₂=1-50, n₃=1-24.

Further triazines containing active hydrogen are carbamoylated derivatives of any of the above hydroxy functional triazines, that is, triazines containing —OC(O)NHR⁹ functionality.

Further triazine precursors, containing an active methylene are also suitable. In this case —YH is —Z—CHR—Z′ or Z—NH—Z′ in which:

Z is —CO—, —CO—M⁺, —CONR⁹, —SO—or —SO₂; and

Z′ is —COOR⁹, —COO⁻M⁺, —CHO, —COR⁹, —CONR⁹, —CN, —NO₂, —SOR⁹, —SO₂R⁹, —SO₂OR⁹, or —SO₂NR₂⁹;

and in which the Z group is linked to any of the hydroxy functional triazines listed above.

### PROCESS FOR PREPARATION

The aminoplast anchored monomeric or oligomeric triazine UV absorbers of the present invention are prepared by reacting a functional triazine UV absorber with an amino resin, e.g. a melamine, guanimine (benzoguanimine, cyclohexylguanamine and acetoguanimine), glycouril or urea-formaldehyde resin. Suitable reactive functionality for the triazine UV absorber are hydroxyl, carbamoyl and active ethylene (e.g. acetoacetate or malonate). Hydroxyl functional UV absorbers are well known in the art.

The driving force for the acid catalysed reaction between the reactants is the generation, from the alkoxymethylated or hydroxymethylated aminoplast reactant, of a positively charged electrophilic center on the methylene group of the alkoxymethyl or hydroxymethyl attached to the aminoplast by elimination of the elements of an alcohol or water from a protonated aminoplast. The positively charged electrophilic center then reacts with the electron-rich hydroxyl, carbamoyl or enol (derived from the activated methylene) group of the triazine.

The ratio of functional triazine to amino resin depends on the number of active methylol or alkoxymethyl groups present in the amino resin. The equivalents of functional triazine being equal or less than the equivalents of methylol or alkoxymethyl groups. For example, Cymel® 300 has nearly 6 equivalents of alkoxymethyl groups. Therefore the ratio of functional triazine to amino resin is from 0.1 to 6. The preferred molar ratio is 1 to 3.

The reaction is carried out in an inert solvent, preferably an aromatic solvent such as toluene or chlorobenzene, in the presence of an acid catalyst. Examples of acid catalysts are mineral acids, aliphatic and aromatic sulfonic acids (e.g. p-toluene sulfonic acid, dinonylnaphthalene disulfonic acid, dodecylbenzene sulfonic acid), oxalic acid, maleic acid, hexamic acid, phosphoric acid, polyphosphoric acid, alkyl phosphate esters, phthalic acid and acrylic acid copolymers. Preferable acid catalysts are p-toluene sulfonic acid and nitric acid. The amount of catalyst used is typically between 0.01 and 0.2 mole percent. This is in contrast to prior art aminoplast—anchored triazines described in U.S. Pat. No. 5,547,753, U.S. Pat. No. 5,612,084 and U.S. Pat. No. 5,621,052. The process used therein involves not a catalytic amount of acid, but rather the use of concentrated sulfuric acid as the solvent. It is well known to those skilled in the art that under these conditions, concentrated sulfuric acid is in large excess, and self-condensation of the amino resins to produce insoluble, cross-linked resin will be a major problem.

The reaction is carried out at a temperature of from about 20° C. to 150° C., with the maximum temperature depending on the boiling point of the solvent and the presure used. Since the reaction involves a series of equilibria, it is desirable that the temperature be above the boiling point of the alcohol evolved during the reaction. In this way the alcohol is removed by distillation during the course of the reaction, thereby driving the reaction to completion.

### THERMOPLASTIC POLYMER COMPOSITIONS

The novel compositions of matter described above are useful as ultraviolet (UV) stabilizer additives for polymers, particularly as additives for thermoplastic polymers and thermoset systems. They may he added to the polymer to impart useful stabilizing properties to the polymer by themselves or in combination with antioxidant or hindered amine stabilizers.

In the stabilization of thermoplastic polymers such as polyethylene, polypropylene, polyvinylchloride, polystyrene, polycarbonates, polyurethanes, polyamides, and the like, the novel aminoplast anchored stabilizers of the Invention are simply incorporated into thermoplastic materials at a level in the range of about 0.01 to about 20 weight percent by methods known in the art.

### CURABLE COMPOSITION

In thermoset coating applications, the aminoplast anchored stabilizers of the invention are used to prepare a novel curable composition which composition is thereafter cured to produce light stable films and objects.

The novel curable composition of the invention comprises:

(i) a stabilizingly effective amount of a stabilizer comprising an aminoplast anchor having more than 0.5 mole of phenolic stabilizer group per mole of aminoplast pendently attached thereto;

(ii) a crosslinkingly effective amount of a crosslinking agent; and

(iii) a polyfunctional active hydrogen containing material.

The preferred curable compositions comprise a stabilizer (i), which is a stabilizer of the invention, in an amount of at least 0.01 weight percent of the total weight of the curable composition.

Typically, the novel curable composition of the invention comprises:

(i) about 0.01 to 20 weight percent of a novel stabilizer of the invention;

(ii) about 3 so 55 weight percent of a crosslinking agent; and

(iii) about 40 to 97 weight percent of a polyfunctional active hydrogen containing material.

The curable composition, optionally, may contain a cure catalyst to accelerate curing. The curing catalyst is selected from the group comprising acids, amines, amino group containing resins, organometallic compounds and phosphine. The novel stabilizers of the invention are described hereinabove in the section entitled “Anchored Products”. They may be blocked or unblocked, monomeric or oligomeric, or they may be mixtures.

The crosslinking agent may be a polyisocyanate or an aminoplast crosslinking agent selected from unetherified, partially etherified or fully etherified aminoplast resins, or it may be any mixture thereof.

The aminoplast crosslinkers are described above in the section entitled “Aminoplast Anchors” and include crosslinkers such as CYMEL® 1130 resin, CYMEL® 303 resin, CYMEL® 1170 resin, POWDERLINK® 1174 resin, CYMEL® 1123 resin, and the like.

The polyfunctional active hydrogen containing material comprises at least one class of active hydrogen functionality selected from the group consisting of carboxy, hydroxy, amido, mercapto, and a group convertible thereto. The hydroxy and carboxy functional groups are preferred.

Especially suitable polyfunctional active hydrogen containing materials include polyesters, polyacrylates, polyurethane polyols, and products of condensation of amines with epoxy resins, all containing hydroxy groups as reaction sites. The polyesters are obtained in a known manner by, for example, the reaction of polyfunctional carboxylic acids with excess quantities of polyhydric alcohols; the polyacrylates are obtained by the copolymerization of acrylic or methacrylic acid derivatives with hydroxy group containing derivatives of these acids, such as, for example, the hydroxyalkyl esters, optionally with the simultaneous use of additional vinyl compounds, such as, for example, styrene. The hydroxy group containing polyurethanes can be obtained, in a known manner, by the reaction of polyisocyanates with excess quantities of compounds containing at least two hydroxy groups.

Suitable commercially available hydroxy group containing polyesters are CYPLEX® 1531, a polyester of phthalic acid, adipic acid, ethanediol, and tri-methylol propane from Cytec Industries, Inc., Cargil Polyester 5776, available from Cargil, and TONE® 0200 available from Union Carbide Corp. Suitable hydroxy functional acrylic resins are available commercially from S. C. Johnson & Son, Inc. under the trademark JONCRYL® 500, a copolymer of styrene, hydroxypropyl methacrylate and butyl acrylate, and from Rohm & Hass Co. under the trademark AT-400. Also suitable for use are hydroxy-terminated polycaprolactones.

The hydroxyfunctional polyfunctional active hydrogen containing material comprises compounds and resins selected from acrylic resins, polyester resins, polyurethanes, polyols, products derived from the condensation of epoxy resins with amines, and mixtures thereof.

A cure catalyst to accelerate the crosslinking reaction may be also optionally used, however, the curable compositions of the invention may be capable of curing without an added catalyst.

When a catalyst is present, crosslinking takes place more rapidly at a particular temperature than when a catalyst is not present.

Typically, crosslinking is effected at a lower temperature with a catalyst present.

The acid cure catalysts usable in the invention include carboxylic acids such as phthalic and oxalic acids; sulfonic acids such as para-toluenesulfonic acid, dinonyl naphthalenesulfonic acid, naphthalene sulfonic acid, dodecylbenzenesulfonic acid; phosphoric acids; mineral acids such as nitric acid, sulfuric acid, phosphoric acid, polyphosphoric acid, and the like. The use of a sulfonic acid is preferred.

When employed, the cure catalyst is used in the curable compositions of the invention in amounts effective to accelerate cure at the temperature employed. For example, the catalyst is typically used in amounts of from about 0.01 to about 2% by weight, with 0.02 of 1% by weight, based on the weight of the curable compositions, being preferred.

In the practice of the invention, the curable compositions can be adapted for use in solvent-based, water-based, and powder coating applications. They may also be used in molding applications. Sulfonimide catalysts are particularly well suited for use in powder coating applications.

The curable compositions of the invention may also contain other stabilizers such as monomeric or oligomeric hindered amine light stabilizers (HALS), phenolic antioxidants, phosphite antioxidants, sulfur containing antioxidants such as sulfides and disulfides, other UV absorbers, acid scavengers, fillers, pigments, flame retardants, and the like.

### METHOD OF USING

This invention is also an improved method of using the aminoplast anchored novel stabilizers of the invention described above in the section entitled “Anchored Products.” The method utilizes the novel curable compositions of the invention also described above in the section entitled “Curable Compositions.”

The novel method described herein is an improved method of coating substrates of the type having the steps of (I) contacting said substrate with a conventional curable composition containing a stabilizer, a crosslinking agent, and a polyfunctional active hydrogen containing material, and (II) thereafter curing said conventional curable composition, wherein the improvement comprises:

(a) contacting said substrate with a novel curable composition comprising:

(i) a stabilizingly effective amount of a stabilizer comprising an aminoplast anchor having more than 0.5 mole of phenolic stabilizer group per mole of aminoplast pendently attached thereto;

(ii) a crosslinkingly effective amount of a crosslinking agent; and

(iii) a polyfunctional active hydrogen containing material; and

(b) thereafter curing said novel curable composition. The substrate to be coated may be selected from surfaces such as steel, aluminum, plastic materials, and the like. Alternatively, a mold may be used instead of a surface to practice the method of the invention.

The contacting of a substrate with the novel curable composition of the invention may be carried out by any of the conventional coating methods including spraying, padding, brushing, electrostatic spraying as is the case in powder coatings, roller coating, curtain coating, flow coating, dipping, and electrocoating.

The curing may be carried out by continued application of heat at an elevated temperature or at an ambient temperature.

The cure may be accelerated by the use of a suitable catalyst such as those used to cure the novel curable compositions.

### STABILIZED ARTICLES

The novel method of using the anchored stabilizers of the invention according to the method described above produce a product, which, in this case, is a crosslinked article in the form of a film such as coatings, or it is in the form of an article such as a molded product.

The cured compositions may be used as coatings for wire, appliances, automotive parts, furniture, pipes, machinery, and the like. Surfaces which arc suitable include plastics, wood, and metals such as steel, aluminum, and the like.

The cured compositions may also be used to form solid articles such as cases, enclosures, and structural members.

The following examples illustrate the preparation and use of the novel stabilizers of the invention by the process of the invention. These examples are not, however, intended to limit the claims in any manner whatsoever.

### EXAMPLES

### Examples 1 - 8

The melamine-formaldehyde resins used in these examples, Cymel® 300 and 303 resins, represent two commercial grades of hexamethoxymethylmelamine (HMMM) available from Cytec Industries, Inc. Some physical properties are given in Table I.

TABLE I
Some Physical Properties of Cymel 300 and 303 Resins

| | Cymel 300 | Cymel 303 |
|---|---|---|
| Non-volatiles | >98% | >98% |
| Viscosity (Gardner- | Waxy solid | X-Z2 |
| Holt, 25° C.) | | |
| HMMM Monomer content, | 75 | 58 |
| Approx. | | |
| Degree of | 1.35 | 1.7 |
| Polymerization | | |

These resins are predominantly monomeric HMMM, but lower levels of dimeric and trimeric analogs which are linked either through methylene, —NCH₂N—, bridges, or methyleneoxy, —NCH₂OCH₂N—, bridges are also present. For Cymel® 303 resin, the combined methanol, or degree of methylation ranges between 5.1 and 5.3 moles per mole of melamine. The methylol content, —CH₂OH, is 1.5-2.0%, and the imino, —NH, content is very low.

Idealized structures representing the 1:1 adducts of Cymel® 300 and 303 with bondable tris-aryl-1,3,5-triazine UV absorbers are given in the examples. However HPLC analyses indicate that several distinct species are formed in each reaction. These include mono-, bis-, tris- and higher-substituted species, i.e. melamine “anchors” bonded to one, two, three, or more tris-aryl-1,3,5-triazine chromophore units. Oligomeric species bridged by methylene or methyleneoxy bridges are also present.

### Example 1

### 1:1 Adduct Between Cymel® 300 and 2,4-Bis(2,4-dimethylphenyl)-6-[2-hydroxy-4-(2-hydroxyethoxy)phenyl1]-1,3-5-triazine (Compound A)

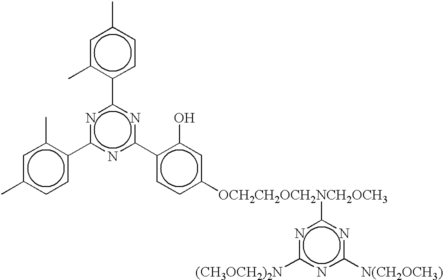

### Idealized

Structure of Compound A

2,4-Bis(2,4-dimethylphenyl)-6-[2-hydroxy-4-(2-hydroxyethoxy)phenyl]-1,3-5-triazine (Compound a, 10.0 g, 22.6 mmol) was dissolved in 100 mL of chlorobenzene at 80° C. Cymel® 300 (8.64 g, 22.6 mmol based on an assumed MW of 382) and 0.43 g of para-toluenesulfonic acid (2.3 mmol) were added. The solution was stirred at 133-136° C. for 11 hrs. During this time, 2.8 mL of fluid were collected in a Dean-Stark trap. The mixture was then washed with 50 mL of 5% aq. sodium bicarbonate, 50 mL of water, and 50 mL of saturated aq. sodium chloride. The organic layer was dried over anhydrous potassium carbonate, filtered, and concentrated in vacuo affording 15.05 g (84% of theoretical yield) of Compoud A as a yellow glass.

### Example 2

### 1:1 Adduct Between Cymel® 300 Resin and 2,4-Bis(2,4-dimethylphenyl)-6-[2-hydroxy-4-(6-hydroxyhexyloxy)phenyl-1,3-5-triazine (Compound B)

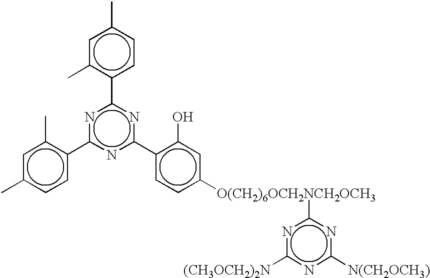

### Idealized Structure for Compound B

To a 250 mL round-bottom flask equipped with a magnetic stir bar and a distillation head connected to a distillation condenser were charged 20.0 g of 2,4-bis(2,4-dimethylphenyl)-6-[2-hydroxy-4-(6-hydroxyhexoxy)phenyl]-1,3-5-triazine (40.0 mol), 15.4 g of Cymel® 300 (40.0 mmol based on an assumed MW of 382), 0.60 g of para-toluenesulfonic acid (3.15 mmol) and 150 mL of toluene. The flask was immersed in an oil bath and the bath temperature brought to 80° C. A vacuum was applied to the system using a water aspirator such that a liquid began distilling over slowly. After collection of 30 mL of distillate over ca. 3 hours, no starting material was observed by TLC (10% acetone/methylene chloride). The organic layer was extracted with 2×200 mL of 0.5 N potassium bicarbonate and dried overnight over magnesium sulfate. Filtration and rotary evaporation, followed by vacuum treatment at 75° C. for 15 hours gave 34.2 g of an orange glass (100.3% of theoretical yield). The structure was confirmed by ¹H-NMR. HPLC analysis showed at least four major peaks containing the tris-aryl-1,3,5-triazine chromophore and essentially no starting material.

### Example 3

### 1:1 Adduct Between Cymel® 300 Resin and 2,4-is (2,4-dimethylphenyl)-6-[2-hydroxy-4-(6-carbamoyloxyhexyloxy)phenyl]-1,3-5-triazine) (Compound C)

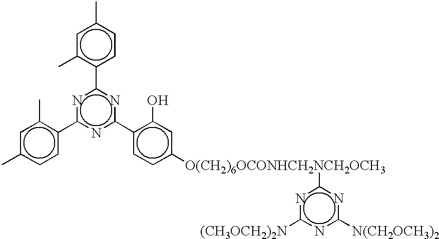

### Idealized Structure for Compound C

To a 250 mL round-bottom flask equipped with a magnetic stir bar and a distillation head connected to a distillation condenser were charged 20.0 g of 2,4-bis(2,4-dimethylphenyl)-6-[2-hydroxy-4-(6-carbamoyloxyhexoxy)phenyl]-1,3-5-triazine (37.0 mol), 14.1 g of Cymel® 300 (37.0 mmol based on an assumed MW of 382), 0.60 g of para-toluenesulfonic acid (3.15 mmol) and 150 mL of toluene. The flask was immersed in an oil bath and the bath temperature brought to 74° C. A vacuum was applied to the system using a water aspirator such that a liquid began distilling over slowly. After collection of 45 mL of distillate over ca. 2 hr., no starting material was observed by TLC (10% acetone/methylene chloride). The organic layer was extracted with 2×150 mL of 0.5 N potassium bicarbonate, diluted with 100 mL of methylene chloride and dried overnight over magnesium sulfate. Filtration and rotary evaporation, followed by vacuum treatment at 75° C. for 15 hours gave 32.4 g of an orange glass (98.5 % of theoretical yield). The structure was confirmed by 1H-NMR. HPLC analysis showed at least eight major peaks containing the tris-aryl-1,3,5-triazine chromophore and essentially no starting material.

### Example 4

### 1:1 Adduct of Cymel® 303 Resin with 4-[4,6-Bis(2,4-dimethylphenyl)-1,3,5-triazin-2-yl]-3-hydroxyphenoxyacetic acid, N-(2-hydroxyethyl)amide (Compound D)

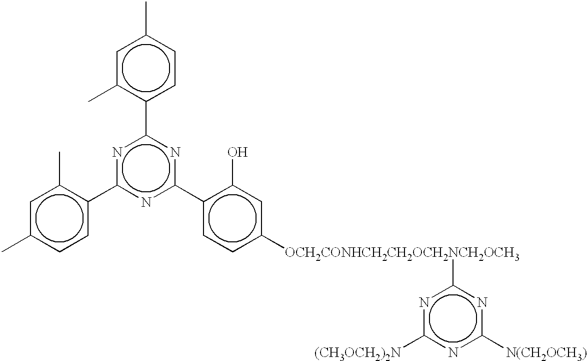

### Compound D, Idealized Structure

A mixture of 370 mg of Cymel® 303, 500 mg of 4-[4,6-Bis(2,4-dimethylphenyl)-1,3,5-triazin-2-yl]-3-hydroxyphenoxyacetic acid, N-(2-hydroxyethyl)amide, and 10 mg p-TSA was stirred in refluxing toluene for 6 hr. TLC analysis of the reaction mixture revealed that the N-(2-hydroxyethyl)amide starting material was almost completely reacted with the Cymel resin. The product was then isolated by removing toluene in vacuo to give predominantly the 1:1 adduct.

### Example 5

### 1:1 Adduct of Cymel® 300 Resin with 4-[4,6-Bis(2,4-dimethylphenyl)-1,3,5-triazin-2-yl]-3-hydroxyphenoxyacetic acid N-(2-(2-hydroxyethoxy)ethyl)amide (Compound E)

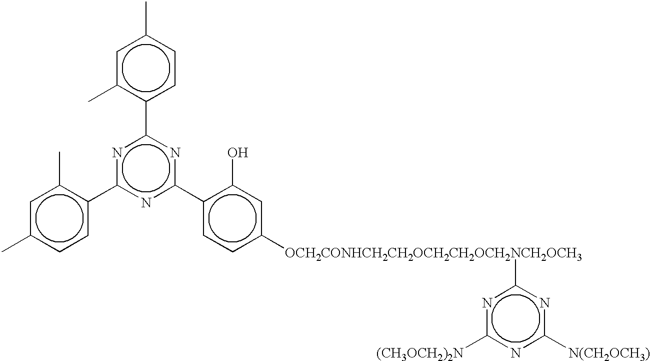

### Compound E, Idealized Structure

A mixture of 1.41 g of Cymel® 300, 2.0 g of 4-[4,6-bis(2,4-dimethylphenyl)-1,3,5-triazin-2-yl]-3-hydroxyphenoxyacetic acid, N-(2-(2-hydroxyethoxy)ethyl)amide, and 42 mg p-TSA was stirred in 100 mL refluxing toluene for 2 hr. HPLC analysis of the reaction mixture revealed that the N-(2-(2-hydroxyethoxy)ethyl)amide starting material was completely reacted with the Cymel resin. The mixture was washed with 100 mL 5% aq. sodium carbonate and 100 mL of water. The organic layer was concentrated in vacuo to give Compound E as a yellow glass. HPLC analysis showed four major peaks containing the tris-aryl-1,3,5-triazine chromophore.

### Example 6

### 1:1 Adduct of Cymel 303 Resin with 4-[4,6-Bis(2,4-dimethylphenyl)-1,3,5-triazin-2-yl]-3-hydroxyphenoxyacetic acid. N-ethyl-N-(2-hydroxyethyl)amide (Compound F)

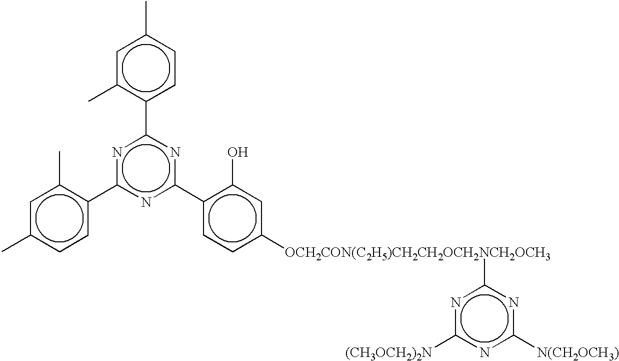

### Compound

F, Idealized Structure

A mixture of 363 mg of Cymel® 300, 500 mg of 4-[4,6-bis(2,4-dimethylphenyl)-1,3,5-triazin-2-yl]-3-hydroxyphenoxyacetic acid, N-ethyl-N-(2-hydroxyethyl)amide, and 10 mg p-TSA was stirred in 10 mL refluxing toluene. HPLC analysis of the reaction mixture revealed that the N-(2-(2-hydroxyethoxy)ethyl)amide starting material was completely reacted with the Cymel resin. The mixture was washed with 10 mL 5% aqueous sodium carbonate and 10 mL of water. The organic layer was concentrated in vacuo to give Compound F as a pale yellow glass. HPLC analysis showed at least eight major peaks containing the tris-aryl triazine chromophore.

### Example 7

### 1:1 Adduct of Cymel® 303 Resin with 2,4-bis(2,4-dimethylphenyl)-6-[2-hydroxy-4-(acetoacetyloxyethoxy)phenyl]-1,3-5-triazine (Compound G)

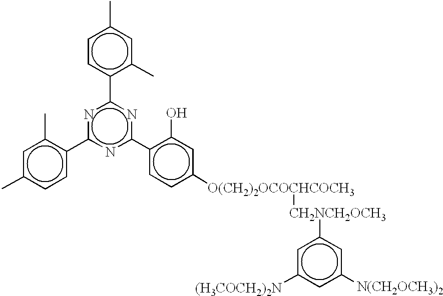

### Compound G,

Idealized Structure

A mixture of 3.63 g of Cymel® 300, 5.0 g of 2,4-bis(2,4-dimethylphenyl)-6-[2-hydroxy-4-(acetoacetyloxyethoxy)phenyl]-1,3-5-triazine, and 182 mg p-TSA was stirred in 100 mL refluxing toluene for 4 hr. HPLC analysis of the reaction mixture revealed that the acetoacetate starting material was completely reacted with the Cymel resin. The mixture was washed with 100 mL 5% aqueous sodium carbonate and 60 mL deionized water. The organic layer was dried over anhydrous magnesium sulfate and filtered. The filtrate was concentrated in vacuo to give Compound G as a yellow glass. HPLC analysis showed ten major peaks containing the tris-aryl triazine chromophore.

### Example 8

### 1:1 Adduct of Cymel® 300 Resin with 2,4-bis(2,4-dimethylphenyl)-6- [2-hydroxy-4-(acetoacetyloxyhexoxy)phenyl]-1,3-5-triazine (Compound H)

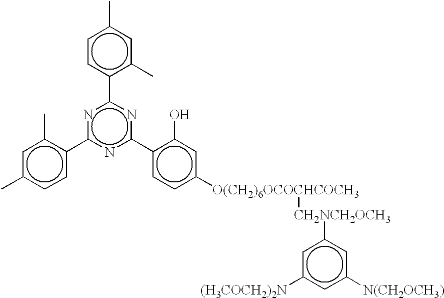

### Idealize

d Structure of Compound H

A mixture of 352 mg of Cymel® 300, 500 mg of 2,4-bis(2,4-dimethylphenyl)-6- [2-hydroxy-4-(acetoacetyloxyhexyloxy)phenyl]-1,3-5-triazine, and 10 mg p-TSA was stirred in 10 mL refluxing toluene for 5 hr. HPLC analysis of the reaction mixture revealed that acetoacetate starting material was almost completely reacted with the Cymel resin. The mixture was washed with 15 mL 5% aqueous sodium bicarbonate and 15 mL of water. The organic layer was concentrated in vacuo to give a pale yellow glassy solid. HPLC analysis of the product showed nine major peaks containing the tris-aryl-1,3,5-triazine chromophore plus 10.5% acetoacetate starting material (HPLC area % at 290 nm).

### Example 9

### Relative Solubilities in Toluene

The solubilities of bondable tris-aryl-1,3,5-triazine UV absorbers and the corresponding 1:1 amino resin adducts are summarized in Table II. The data show how the relatively insoluble bondable tris-aryl-1,3,5-triazine UV absorbers are made highly soluble by reaction with amino resins.

TABLE II
Solubilities of Triazine UVA's and the
Corresponding 1:1 Amino Resin Adducts in Toluene at 23° C.

| | Solubility of | Solubility of 1:1 |
|---|---|---|
| | Triazine Starting | Amino Resin Adduct |
| Compound | Material (wt %) | (wt %) |
| a | <1 | |
| A | | >80 |
| b | <10 | |
| B | | >80 |
| c | <1 | |
| C | | >80 |
| d | 1 | |
| D | | >50 |
| e | <1 | |
| E | | 20 |
| f | <10 | |
| F | | 25 |
| g | 10 | |
| G | | 20 |

Compound a is 2,4-bis(2,4-dimethylphenyl)-6-[2-hydroxy-4-(2-hydroxyethoxy)phenyl]-1,3-5-triazine.

Compound b is 2,4-bis(2,4-dimethylphenyl)-6-[2-hydroxy-4-(6-hydroxyhexoxy)phenyl]-1,3-5-triazine.

Compound c is 2,4-bis(2,4-dimethylphenyl)-6-[2-hydroxy-4-(6-carbamoyloxyhexoxy)phenyl]-1,3-5-triazine.

Compound d is 4-[4,6-Bis(2,4-dimethylphenyl)-1,3,5-triazin-2-yl]-3-hydroxyphenoxyacetic acid, N-(2-hydroxyethyl)amide

Compound e is 4-[4,6-bis(2,4-dimethylphenyl)-1,3,5-triazin-2-yl]-3-hydroxyphenoxyacetic acid, N-(2-(2-hydroxyethoxy)ethyl)amide

Compound f is 2,4-bis(2,4-dimethylphenyl)-6-[2-hydroxy-4-(acetoacetyloxyethoxy)phenyl]-1,3-5-triazine

Compound g is 2,4-bis(2,4-dimethylphenyl)-6-[2-hydroxy-4-(acetoacetyloxyhexoxy)phenyl]-1,3-5-triazine.

### Example 10

### Solubility/Compatibility of Compound A

A major advantage of alkoxymethylated melamine triazine UV absorbers of the present invention is not only their improved solubility, but also their improved compatibility with coatings resins compared to the corresponding triazine precursors. For example 2,4-bis(2,4-dimethylphenyl)-6-[2-hydroxy-4-(2-hydroxyethoxy)phenyl]-1,3-5-triazine is only soluble in xylenes to the extent of about 0.5%. Its methoxymethylated melamine adduct, Compound A, on the other hand, has a xylenes solubility of greater than 10%. Therefore Compound A is much easier to dissolve in high solids coating resin formulations than 2,4-bis(2,4-dimethylphenyl)-6-[2-hydroxy-4-(2-hydroxyethoxy)phenyl]-1,3-5-triazine, and overcomes the problem of cratering and poor weatherability of the final coatings due to undissolved UV absorber particles.

### Example 11

### Migration Studies on Compound B in a Thermoset Acrylic Melamine Coating System

Compound B was incorporated at a 5% level in an acrylic/melamine clear coat formulation (Joncryl 510/Cymel-303), and the formulation was drawn down on an aluminum panel. The coating was cured partially at 135° C. for 10 min. and a top clear coat (containing no UV absorber) was applied. The two layers were then cured fully at 135° C. for 30 min. Sections of the cured coating with a thickness of 10 μm were obtained using a microtome and each section analyzed for UV absorbance at 340 nm. Essentially no absorbance was observed in the sections at depths corresponding to the top layer, while a sharp increase in absorbance was observed in the sections taken at depths corresponding to the second layer. (See FIG. 1.) This demonstrates that little or no migration of the UVA from the lower layer to the upper layer had occurred during curing.

[image]

### Example 12

### Weatherability of Coating Compositions Containing Compound A

Hydroxyl-functional triazine UV absorber 2,4-bis(2,4-dimethylphenyl)-6-[2-hydroxy-4-(2-hydroxyethoxy)phenyl]-1,3-5-triazine and its amino resin adduct Compound A were formulated in clear acrylic melamine coatings which were applied to E-coated steel panels for accelerated weathering testing as follows. 2,4-Bis(2,4-dimethylphenyl)-6-(2-hydroxy-4-(2-hydroxyethoxy)phenyl]-1,3-5-triazine (2% based on total resin solids) was pre-dissolved in a mixture of xylenes and isopropyl alcohol, and added to the clear acrylic melamine formulation given in Table III. Similarly, Compound A (2.3% based on total resin solids) was pre-dissolved in mixtures of xylenes and isopropyl alcohol, and added to a separate clear coat formulation. The amount of Compound A was adjusted upwards to maintain the same moles of tris-aryl-1,3,5-triazine UV chromophore in both formulations. After appropriate viscosity adjustment, an unstabilized clear formulation was sprayed onto steel panels pre-coated with grey ED5000 E-coat and measuring 4″×12″ (ACT Laboratories, Inc. Hillsdale, Mich.). Then the stabilized clear formulations were sprayed wet-on-wet over the unstabilized base coat. Coatings 3.4 mil thick were obtained. The clear coats were allowed to flash for 10 min. at ambient temperature and cured for 30 min. at 135° C.

TABLE III
Acrylic Melamine Clear Coat Formulation

| Material | Amount | |
|---|---|---|
| Joncryl ® 510 acrylic | 81.25 | g |
| Cymel ® 303 crosslinker | 35.0 | g |
| Cycat ® 4040 catalyst | 1.0 | g |
| n-Butanol | 20.0 | g |
| Xylene | 16.0 | g |
| UV Absorber^{a} | 2.0 | g |

^{a}Amount for 2% based on total resin solids

Accelerated weathering was carried out with a QUV device equipped with UVB-313 fluorescent bulbs. A weathering protocol based on ASTM G53 (GM cycle), was used: alternate cycles of (i) UV light at 70 C. for 8 hours and (ii) condensation with no UV light at 50 C. for 4 hr. Percent gloss retention and cross-hatch adhesion (ASTM D3359) were measured as a function of weathering time. Since the epoxy E-coat like those used on these panels are known to be particularly sensitive to light, resistance of the clear coats to delamination is a good measure of UV absorber effectiveness. The cross-hatch adhesion test results are summarized in Table IV. Adhesion is ranked on a scale of 0 to 5, with 5 being the best. Both stabilizers offer improved delamination resistance over the unstabilized coating, but the amino-resin adduct, Compound A, is superior to its hydroxyl-functional precursor, 2,4-bis(2,4-dimethylphenyl)-6-[2-hydroxy-4-(2-hydroxyethoxy)phenyl]-1,3-5-triazine. In terms of surface properties, Compound A also affords improved gloss retention over 2,4-bis(2,4-dimethylphenyl)-6-[2-hydroxy-4-(2-hydroxyethoxy)phenyl]-1,3-5-triazine (Table V).

TABLE IV
Effect of Compound A on Clear-coat Adhesion Over
an Epoxy E-Coat

Hours QUV Exposure

| Stabilizer | 162 | 438 | 628 | 985 |
|---|---|---|---|---|
| None | 3 | 2 | 0^{a} | — |
| 2.0% a | 5 | 3− | 3− | 2 |
| 2.3% A | 4− | 4− | 4 | 4+ |

^{a}Coating failed.

Compound a is 2,4-bis(2,4-dimethylphenyl)-6-[2-hydroxy-4-(2-hydroxyethoxy)phenyl]-1,3-5-triazine.

TABLE V
Effect of Compound A on Clear-coat Gloss Retention

| | Hours QUV Exposure | | |
|---|---|---|---|
| Stabilizer | 275 | 628 | 985 |
| None | 98.6 | 25%^{a} | — |
| 2.0% a | 97.2 | 91% | 57% |
| 2.3% A | 98.4 | 91% | 74% |

^{a}Coating failed.

Compound a is 2,4-bis(2,4-dimethylphenyl)-6-[2-hydroxy-4-(2-hydroxyethoxy)phenyl]-1,3-5-thiazine.

What is claimed is:

1. A composition of matter comprising a monomeric or oligomeric aminoplast anchor with a trisaryl-1,3,5-triazine UV absorber bonded thereto, and represented by the formula 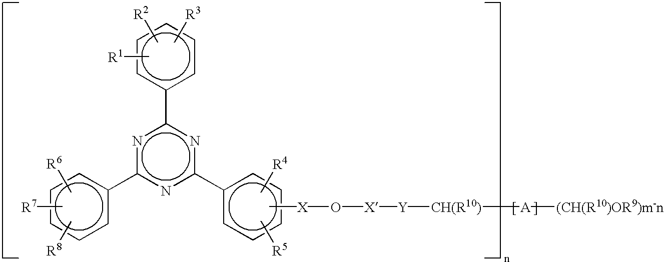
wherein
A is an m-functional monomeric or oligomeric aminoplast anchor molecule having at least 0.1 mole of bondable trisaryl-1,3,5-triazine UV absorber per mole of aminoplast anchor bonded thereto through n bridging groups, such bridging groups being selected from methylene and —CHR¹⁰— groups;
each of R¹-R⁸ are independently selected from hydrogen, cyano, chloro, bromo, nitro, alkyl of 1 to 24 carbon atoms, aryl of 6 to 24 carbon atoms, aralkyl of 7 to 24 carbon atoms, hydroxy, alkoxy of 1 to 24 carbon atoms and alkyl of 1 to 24 carbon atoms optionally substituted by one or more oxygen atoms and/or carbonyl groups, with the proviso that at least one of R¹-R⁸ is ortho to the point of attachment of the triazine ring, and is a hydroxyl or a latent hydroxyl group blocked with an alkyl, phenyl, aryl, acyl, aryl acyl, aminocarbonyl, phosphonyl, sulfonyl or silyl group containing 1 to 18 carbon atoms;
X and X′ are independently a direct bond, a branched or straight chain alkylene group of 1 to 24 carbon atoms, a branched or straight chain alkylene group of 1 to 24 carbon atoms terminated or interrupted by one or more groups selected from —O—, —NH—, —NR⁹—, —CONH—, —CONR⁹, one or more carbonyl groups or combinations thereof;
Y is a direct bond, —CONR⁹—, 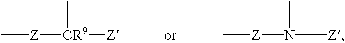
wherein Z is —CO—, —CO⁻M⁺, —CONR⁹, —SO— or —SO₂; and Z′ is —COOR⁹, —COO⁻M⁺, —CHO, —COR⁹, —CONR⁹, —CN, —NO₂, —SOR⁹, —SO₂R⁹, —SO₂OR⁹, —SO₂NR₂⁹;
R⁹ and R¹⁰ are independently selected from the group consisting of hydrogen, linear or branched alkyl of 1 to 24 carbon atoms, aryl of 6 to 24 carbon atoms or aralkyl of 7 to 24 carbon atoms;
m is at least 1; and
n is at least 0.1.

2. The composition of matter of claim 1, wherein the aminoplast anchor is selected from the group consisting of 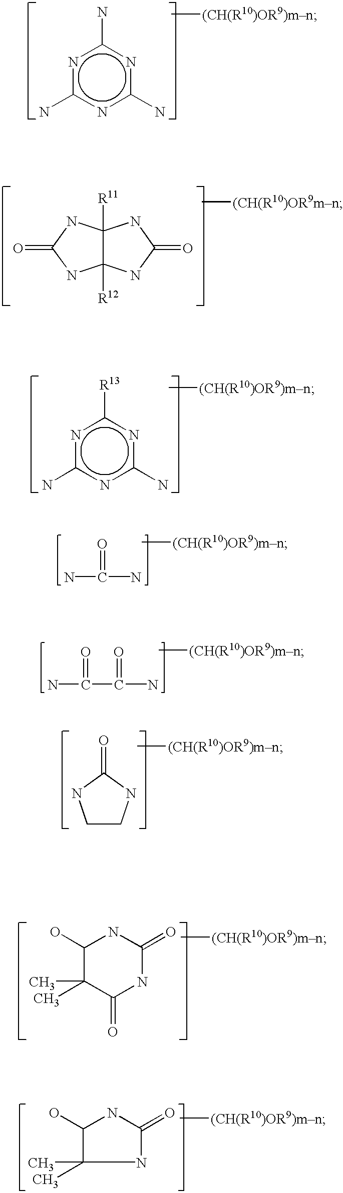
polyfunctional carbamates;
polyfunctional amides;
hydantoins;
dialkoxyethylene ureas;
dihydroxyethylene urea represented by the formula: 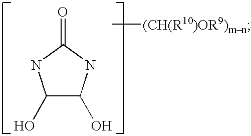
homopolymers and copolymers containing carbamate units of the formula: 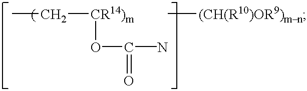
oligomeric derivatives thereof; and non-etherified or partially etherified, substantially fully methylolated or partially methylolated monomeric and oligomeric aminoplasts; wherein
R⁹ is hydrogen or a linear or branched alkyl group of 1 to 24 carbon atoms;
R¹¹ and R¹² are independently, hydrogen, alkyl groups of 1 to 24 carbon atoms or aryl groups of 6 to 24 carbon atoms;
R¹³ is an aliphatic or cycloaliphatic alkyl group of 1 to 24 carbon atoms; an aryl group of 6 to 24 carbon; atoms or an aralkyl group of 7 to 24 carbon atoms; and
R¹⁴ is hydrogen or alkyl of 1 to 24 carbon atoms, and m is at least 1.

3. The composition of matter of claim 2, wherein the aminoplast anchor is a group of the formula 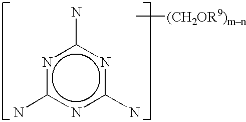
wherein
R⁹ is hydrogen or a linear or branched alkyl group of 1 to 24 carbon atoms.

4. The composition of matter of claim 2, wherein the aminoplast anchor is a group of the formula 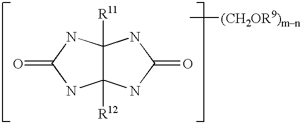
wherein
R⁹ is hydrogen or a linear or branched alkyl group of 1 to 24 carbon atoms; and
R¹¹ and R¹² are independently, hydrogen, alkyl groups of 1 to 24 carbon atoms or aryl roups of 6 to 24 carbon atoms.

5. The composition of matter of claim 2, wherein the aminoplast anchor is a group of the formula 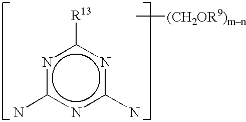
wherein
R⁹ is hydrogen or a linear or branched alkyl group of 1 to 24 carbon atoms; and
R¹³ is an aliphatic or cycloaliphatic alkyl group of 1 to 24 carbon atoms; an aryl group of 6 to 24 carbon atoms or an aralkyl group of 7 to 24 carbon atoms.

6. The composition of matter of claim 2, wherein the aminoplast anchor is a group of the formula 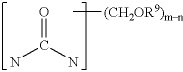
wherein
R⁹ is hydrogen or a linear or branched alkyl group of 1 to 24 carbon atoms

7. The composition of matter of claim 1, represented by the formula 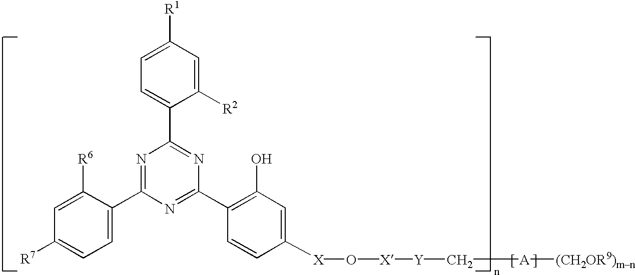
wherein
A is an m-functional monomeric or oligomeric aminoplast anchor molecule to which n bondable trisaryl-1,3,5-triazine UV absorbers are bonded through a methylene linkage;
X, X′ and Y are as described above;
R¹, R², R⁶ and R⁷ are independently selected from hydrogen, chloro, cyano, alkyl of 1 to 24 carbon atoms, aryl of 6 to 24 carbon atoms and aralkyl of 7 to 24 carbon atoms; and
R⁹ is C¹ to C⁵ alkyl.

8. The composition of matter of claim 7, wherein
X and Y are a direct bonds;
A is the melamine anchor of formula 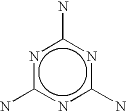
and the divalent group —X′— is selected from 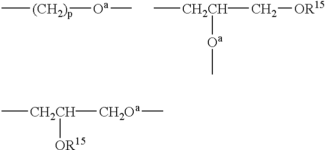
wherein
O^{a} denotes the oxygen atom bonded to the methylene group of the aminoplast anchor;
p is 1 to 24; and
R¹⁵ is hydrogen or a linear or branched alkyl group of 1 to 24 carbon atoms.

9. The composition of matter of claim 7, wherein
X is a direct bond;
A is the melamine anchor of formula 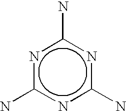
and the divalent group —X′—Y— is selected from
wherein 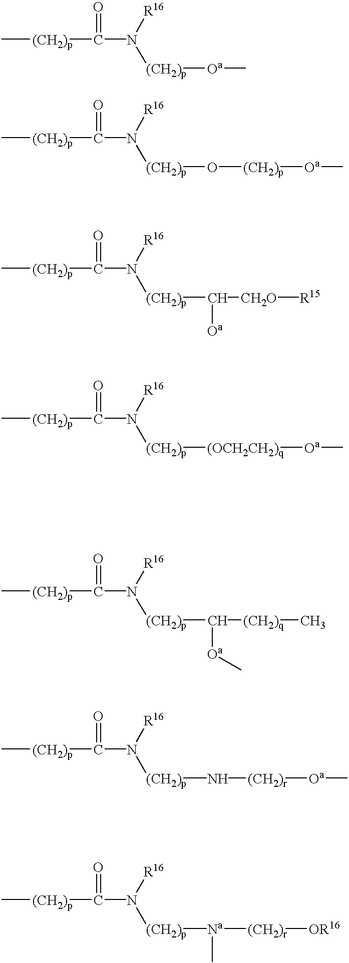
O^{a} and N^{b} denote the oxygen atoms and nitrogen atoms, respectively, bonded to the methylene group of the aminoplast anchor;
p, q and r are each independently 1 to 24; and
R¹⁵ and R¹⁶ are each independently hydrogen or a linear or branched alkyl group of 1 to 24 carbon atoms.

10. The composition of matter of claim 7, wherein
X is a direct bond;
A is the melamine anchor of formula 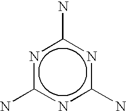
and the divalent group —X′—Y— is selected from 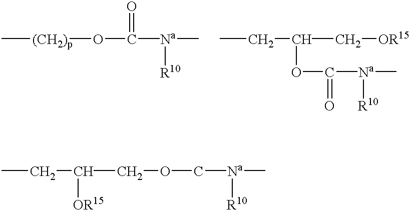
wherein
N^{a} denotes the nitrogen atom bonded to the methylene group of the aminoplast anchor; and
R¹⁰ and R¹⁵ are as defined above.

11. The composition of matter of claim 7, wherein
X is a direct bond;
A is the melamine anchor of formula 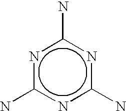
and the divalent group —X′—Y— is selected from 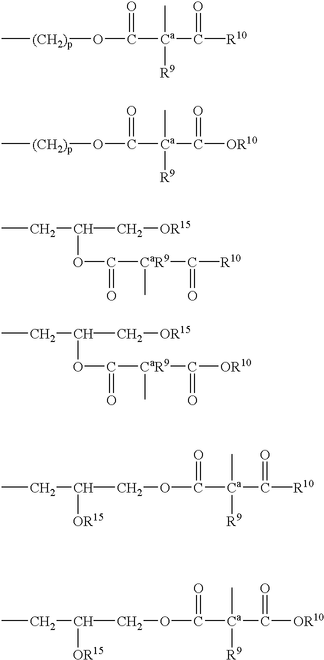
wherein
C^{a} denotes the carbon atom bonded to the methylene group of the aminoplast anchor; and
R⁹, R¹⁰ and R¹⁵ are as defined above.

12. The composition of matter of claim 2, wherein the aminoplast anchor contains a substituent selected from the group comprising a hydrogen, an alkyl or an aryl group of 1 to about 20 carbon atoms, or a stabilizer reactive group of the formula —CH₂OH or —CH₂OR⁹ wherein R⁹ is an alkyl group of 1 to about 20 carbon atoms or another aminoplast anchor group bonded by a methylene or a methylene-oxy-methylene linkage, or a combination of the above groups, provided that, on average, the total number of stabilizer reactive groups per each aminoplast anchor is at least 0.1.

13. The composition of matter of claim 1, wherein the triazine compound is on average reacted with substantially all available reactive sites on the amino resin.

14. The composition of matter of claim 1, wherein the triazine compound is on average reacted with all but one of the available reactive sites on the amino resin.

15. The composition of matter of claim 1, wherein the triazine compound is on average reacted with the amino resin in a ratio so as to leave two or more available reactive sites on the amino resin.

16. The composition of matter of claim 1, further comprising at least 0.1 mole equivalent of a functional UV absorber bonded to the aminoplast anchor, such functional UV absorber being selected from the group consisting of 2-(2-hydroxy-phenyl)-1,3,5-triazines, 2-(2-hydroxyphenyl)benzotriazoles, 2-hydroxybenzophenones, 2-hydroxyoxanilides, salicylic acid derivatives, blocked derivatives thereof and mixtures of any of the preceding light stabilizer groups.

17. The composition of matter of claim 12, wherein the functional UV absorber is a 2-(2-hydroxyphenyl)benzotriazole, and the mole ratio of functional trisaryl-1,3,5-triazine to functional 2-(2-hydroxyphenyl)benzotriazole is between about 1:3 to 3:1.

18. A process for the preparation of an ortho hydroxyphenyl substituted triazine-aminoplast UV absorber of claim 1, which comprises:
reacting sufficient amounts of a suitable functional triazine UV absorber with at least one suitable aminoplast anchor, in the presence of an acid catalyst at a sufficient temperature and for a sufficient time to form an ortho hydroxyphenyl substituted triazine-aminoplast UV absorber.

19. The process of claim 18, further comprising carrying out the reaction in the presence of an inert solvent, wherein the inert solvent does not contain active hydrogen atoms.

20. The process of claim 18, wherein the reaction is carried out at a temperature of from about 20° C. to 150° C.

21. The process of claim 18, wherein the functional triazine UV absorber is defined by the formula 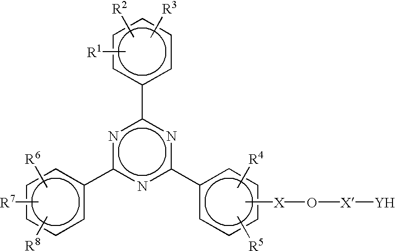
wherein
R¹ to R⁸, X, X′ and Y are as defined above.

22. The process of claim 18, wherein the aminoplast resin is selected from the group consisting of 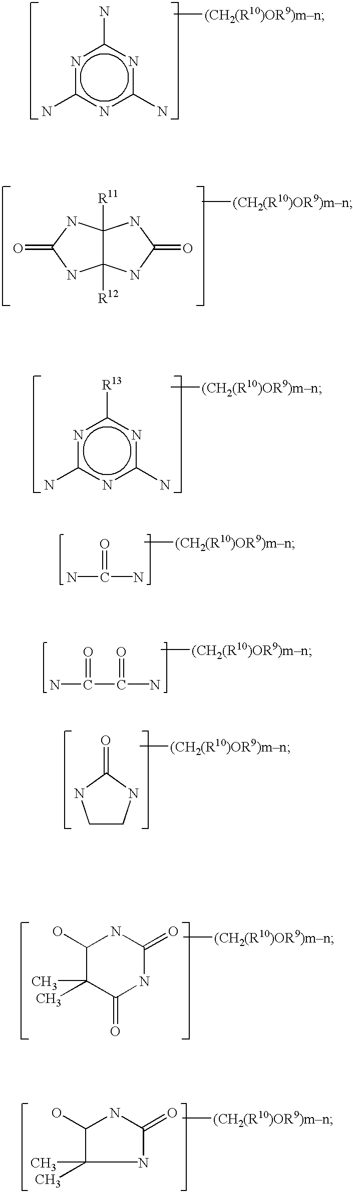
polyfunctional carbamates;
polyfunctional amides;
hydantoins;
dialkoxyethylene ureas;
dihydroxyethylene urea represented by the formula: 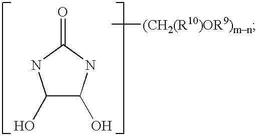
homopolymers and copolymers containing carbamate units of the formula: 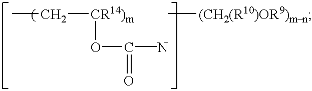
oligomeric derivatives thereof; and non-etherified or partially etherified, substantially fully methylolated or partially methylolated monomeric and oligomeric aminoplasts;
wherein
R⁹ is hydrogen or a linear or branched alkyl group of 1 to 24 carbon atoms;
R¹¹ and R¹² are independently, hydrogen, alkyl groups of 1 to 24 carbon atoms or aryl groups of 6 to 24 carbon atoms;
R¹³ is an aliphatic or cycloaliphatic alkyl group of 1 to 24 carbon atoms; an aryl group of 6 to 24 carbon atoms or an aralkyl group of 7 to 24 carbon atoms; and
R¹⁴ is hydrogen or alkyl of 1 to 24 carbon atoms, and m is at least 1.

23. The process of claim 22, wherein the aminoplast anchor is a group of the formula 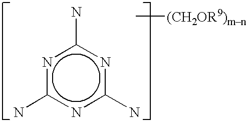
wherein
R⁹ is hydrogen or a linear or branched alkyl group of 1 to 24 carbon atoms.

24. The process of claim 22, wherein the aminoplast anchor is a group of the formula 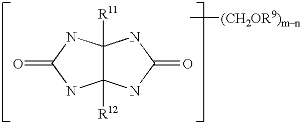
wherein
R⁹ is hydrogen or a linear or branched alkyl group of 1 to 24 carbon atoms.
R¹¹ and R¹² are independently, hydrogen, alkyl groups of 1 to 24 carbon atoms or aryl groups of 6 to 24 carbon atoms; and

25. The process of claim 22, wherein the aminoplast anchor is a group of the formula 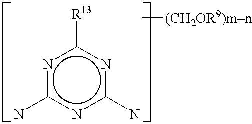
wherein
R⁹ is hydrogen or a linear or branched alkyl group of 1 to 24 carbon atoms; and
R¹³ is an aliphatic or cycloaliphatic alkyl group of 1 to 24 carbon atoms; an aryl group of 6 to 24 carbon atoms or an aralkyl group of 7 to 24 carbon atoms.

26. The process of claim 22, wherein the aminoplast anchor is a group of the formula 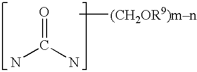
wherein
R⁹ is hydrogen or a linear or branched alkyl group of 1 to 24 carbon atoms.

27. The process of claim 18 wherein is used from about 0.01 to about 5 wt % of catalyst based on the aminoplast anchor starting material, which the catalyst is selected from the group consisting of carboxylic acids, sulfonic acids, phosphoric acids, mineral acids and combinations thereof.

28. A method of stabilizing a material which is subject to degradation by environmental forces, including ultraviolet light, actinic radiation and oxidation and combinations thereof by incorporating into said material an amount of stabilizer composition effective to stabilize the material against the effects of such environmental forces, wherein the stabilizer composition comprises a composition of matter as set forth in claim 1.

29. The method of claim 28, wherein the material is a substrate selected from a polymeric material, coating, wood or metal.

30. The method of claim 28, wherein the material to be stabilized is a polymer.

31. The method of claim 28, wherein the material to be stabilized is a coating.

32. The method of claim 28, which further comprises incorporating one or more monomeric or oligomeric hindered amine light stabilizers, antioxidants, other UV absorbers, acid scavengers, fillers, pigments or flame retardants.

33. A polymer composition which is stabilized against degradation by environmental forces, including actinic radiation, heat and oxidation, said composition comprising
a) a polymeric material; and
b) an effective stabilizing amount of the composition of claim 1.

34. The stabilized polymer composition of claim 33, wherein the polymer is selected from the group consisting of polyethylene, polypropylene, polyvinyl chloride, polystyrene, polyesters, polyamides, polyurethanes, polycarbonates and mixtures thereof.

35. A coating composition suitable for forming a film stabilized against degradation by environmental forces, including actinic radiation, heat and oxidation, said composition comprising
a) a film-forming binder; and
b) an effective stabilizing amount of the composition of claim 1.

36. The stabilized coating composition of claim 35, wherein the film-forming binder is cured into a cross-linked polymer network.

37. The stabilized curable coating composition of claim 35 comprising
an effective amount of stabilizer composition, wherein the stabilizer composition comprises a composition of matter as set forth in claim 1;
a cross-linker;
a polyfunctional active hydrogen containing material; and
optionally, a curing catalyst comprising an acid, an amine, an amino group containing resin, an organometallic compound or phosphine.

38. The stabilizing curable coating composition of claim 37, wherein the curing catalyst is selected from the group consisting of acids, amines, amino group containing resins, organometallic compounds or phosphine.

39. The stabilized curable coating composition of claim 37, wherein the stabilizer comprises about 0.01-20 weight per cent of the total weight of the curable composition.

40. The stabilized curable coating composition of claim 37 wherein the active hydrogen containing material (iii) is selected from the group consisting of acrylic resins, polyester resins, polyurethane resins, polyols, polycarboxylic acids, polyamides, polyepoxides, and mixtures thereof.

41. The stabilized curable coating composition of claim 37, wherein the aminoplast anchored stabilizer has one or more available reactive sites for bonding to the cross-linker.

42. The stabilized coating composition of claim 35, which further comprises at least one monomeric or oligomeric hindered amine light stabilizer, or combinations thereof.

43. The stabilized coating composition of claim 35, which further comprises one or more ultraviolet light stabilizers other than the composition of claim 1.

44. The stabilized coating composition of claim 43, wherein the additional ultraviolet light stabilizer is a 2-(2-hydroxyphenyl)benzotriazole.

45. The stabilized coating composition of claim 43, wherein the additional ultraviolet light stabilizer is a 2-(2-hydroxyphenyl)-1,3,5-triazine.

46. The stabilized coating composition of claim 43, which further comprises at least one monomeric or oligomeric hindered amine light stabilizer, or combinations thereof.
